(19) United States
(12) Patent Application Publication
(10) Pub. No.: US 2004/0052449 A1
(43) Pub. Date: Mar. 18, 2004

(54) Optical multiplexer/demultiplexer having decreased channel spacing

(76) Inventors: William R. Trutna JR., Atherton, CA (US); Brian E. Lemoff, Union City, CA (US); Peter Zhao, Palo Alto, CA (US); Kenneth R. Wildnauer, Santa Rosa, CA (US); Dale W. Schroeder, Scotts Valley, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/243,216

(22) Filed: Sep. 12, 2002

(51) Int. Cl. G02B 6/28

(52) U.S. Cl. 385/24; 385/36; 385/37

(57) ABSTRACT

The optical multiplexer/demultiplexer comprises an input/output channel array, a diffractive element, an arraying device and a converging element. The input/output channel array is located adjacent an optical axis and includes input/output channels arrayed in a first direction, orthogonal to the optical axis, at a predetermined pitch. The diffractive element is arranged to receive light from the input/output channel array at a location separated from the input/output channel array along the optical axis. The diffractive element diffracts the light to array the light wavelength-dependently in a second direction, different from the first direction. The arraying device receives light diffracted by the diffractive element and arrays the light in the first direction at a pitch equivalent to the predetermined pitch. The converging element is located along the optical axis between the diffractive element and either or both the arraying device and the input/output channel array.

### BACKGROUND OF THE INVENTION

With advances in technology, there is a continuous demand to increase data transmission rates and the volume of data transmission. Traditional communication lines, such as copper wires, have been used to meet this continuous demand. However, traditional communication lines are subject to many disadvantages including limited bandwidth and high signal attenuation, which imposes distance limitations. In addition, traditional communication lines are susceptible to interference during the transmission of data. An example of interference includes, but is not limited to, electromagnetic interference.

Optical fibers overcome many shortcomings of traditional communication lines. Communication via optical fibers is characterized by immunity to electromagnetic interference, long transmission range, and high bandwidth. In fact, telecommunication networks that use optical fibers typically have several Terahertz (THz) of bandwidth available for data transmission.

Until the late 1980s, communication via optical fibers was mainly confined to transmitting a single optical signal along an optical fiber using binary amplitude modulation. However, transmitting a single optical signal via an optical fiber rarely takes advantage of the potentially enormous bandwidth available in the optical fiber. Attenuation in the optical fiber requires that periodic regeneration be performed to maintain the intensity of the optical signal. Regeneration conventionally involves detection of the optical signal, electronic processing of the resulting electrical signal and retransmission of an optical generated in response to the processed electrical signal. Such electronic regeneration limits the data rate due to bandwidth limitations of the electronic processing.

To increase transmission capacity of telecommunication networks based on optical fibers, multiple optical signals, each having a different carrier wavelength, are transmitted simultaneously along a single optical fiber as a multi-wavelength optical signal. This technique is known as wavelength-division multiplexing (WDM). WDM systems in which the channel spacing between adjacent optical signals is reduced are known as dense wavelength division multiplexing (DWDM) systems. In this disclosure, dense wavelength division multiplexing (DWDM) will be regarded as encompassing wavelength-division multiplexing (WDM). In DWDM systems, multiple optical signals, each having a different carrier wavelength, are transmitted on a single optical fiber as a multi-wavelength optical signal.

In DWDM systems, each channel has one particular carrier wavelength assigned to it and carries an individual optical signal. Channel spacing is defined as the frequency difference between the center frequencies of two neighboring channels. A channel spacing of 50 GHz (corresponding to a carrier wavelength difference of approximately 0.4 nm at a wavelength of about 1.55 μm) is commonplace in modern DWDM systems. In future, even smaller channel spacings could be used.

FIG. 1 is a block diagram illustrating a typical dense wavelength division multiplexing (DWDM) communication system 102. Communication system 102 might constitute part of a network, for example. The DWDM communication system transmits multiple information signals represented by a multi-wavelength optical signal carried on a single optical fiber. The multi-wavelength optical signal is composed of multiple single optical signals having different carrier wavelengths.

In a DWDM communication system, each channel carries a single optical signal having an assigned carrier wavelength. The single optical signal typically represents an individual information signal. The channels are separated by a channel spacing defined as described above. Minimizing the channel spacing maximizes the number of single optical signals that can be multiplexed within a given bandwidth. However, the channel spacing must be sufficient to accommodate the frequency sidebands generated by modulating the optical carrier with the information signal. Moreover, the channel spacing must be sufficient to accommodate tolerances in the carrier wavelengths. Finally, the channel spacing must be sufficient to enable the single optical signals to be combined or multiplexed to form the multi-wavelength optical signal and to enable the multi-wavelength optical signal to be separated or demultiplexed into its constituent single optical signals without crosstalk or interference among the single optical signals.

DWDM communication system 102 is composed of an optical transmitter 106, an optical fiber 113 and an optical receiver 108. Optical transmitter 106 receives electrical analog or digital signals and converts each electrical signal into a corresponding single optical signal. The single optical signal is in the form of an intensity-modulated beam of light. Any optical signal source, such as, but not limited to, one of the laser diodes 105 shown, may serve as the source of each single optical signal. Each single optical signal has a carrier wavelength (λ) different from the wavelengths of the other single optical signals with which it will be multiplexed. Single optical signals having carrier wavelengths λ₁, λ₂ and λ₃, respectively, are conveyed by input optical fibers 103A, 103B, 103C, respectively, from their respective optical signal sources to a multiplexer 110 located in the optical transmitter 106.

The multiplexer (mux) 110 combines the single optical signals, each having a different carrier wavelength, to form a multi-wavelength optical signal for transmission to optical receiver 108 via single optical fiber 113. Specifically, multiplexer 110 combines the single optical signals carried by input optical fibers 103A, 103B and 103C to form a multi-wavelength optical signal for transmission via single optical fiber 113.

The multi-wavelength optical signal transmitted by optical transmitter 106 travels via optical fiber 113 to optical receiver 108, which is typically located remotely from the optical transmitter. The optical receiver receives the multi-wavelength optical signal from the optical fiber. A demultiplexer (demux) 114 located in the optical receiver demultiplexes the multi-wavelength optical signal. The demultiplexing separates the multi-wavelength optical signal into its constituent single optical signals. The single optical signals are output via the output optical fibers 107A, 107B, 107C. The information signals represented by the single optical signals obtained by demultiplexing the multi-wavelength optical signal may be detected using known optical signal detection techniques. For example, the photodiode receivers 109 may be used.

In DWDM communication system 102, multiplexer 110 combines two or more single optical signals to form a multi-wavelength optical signal for transmission via optical fiber 113. Demultiplexer 114 separates the multi-wavelength optical signal received from optical fiber 113 into its constituent single optical signals to enable the information signals represented by the single optical signals to be recovered, routed or otherwise processed.

Because of the reciprocal nature of optical devices, a device called an optical multiplexer/demultiplexer (mux/demux) can be used as multiplexer 110. An optical mux/demux having the same structure as that used for multiplexer 110 can be used as demultiplexer 114 simply by reversing the direction of the optical signals. An optical mux/demux is referred to as having m channels, where m is as few as two and as many as forty or more. An m-channel optical mux/demux used as a multiplexer receives m single optical signals having different wavelengths as inputs and outputs an m-channel multi-wavelength optical signal. Used as a demultiplexer, the m-channel optical mux/demux receives an m-channel multi-wavelength optical signal as an input and outputs m single optical signals having different wavelengths.

A prior art optical mux/demux such as the MICS™ mux/demux, manufactured by NetTest A/S of Kirkebjerg Allé 90, 2605 Brøndby, Denmark, can be used as multiplexer 110 or demultiplexer 114 in DWDM transmission system 102. The MICS mux/demux is based on array waveguide grating (AWG) technology. Another example of an AWG-based prior art mux/demux is sold by NTT Electronics Corporation (NEL) of Shibuya Mark City, 1-12-1 Dogenzaka, Shibuya-ku, Tokyo 150-0043, Japan.

An AWG-based mux/demux has a typically Gaussian filter response. The characteristics of an AWG-based mux/demux can be better understood by referring to the graph of FIG. 2. The graph of FIG. 2 plots the insertion loss of a typical AWG-based mux/demux (y-axis) in three adjacent channels against optical frequency (x-axis). Each of the Gaussian filter shapes represents the fraction of the optical power coupled by the AWG-based mux/demux acting as a demultiplexer from the multi-wavelength optical signal to one of the three single optical signals illustrated.

A Gaussian filter has an amplitude response that is non-flat in the pass band and that has a relatively shallow slope in the stop band. The non-flat amplitude response in the pass band distorts the information signal with which the optical signal is modulated. Such distortion may result in an unacceptably-high bit error rate when the optical signal is detected to recover the information signal. The relatively shallow slope of the amplitude response in the stop band means that the frequency spacing between adjacent channels has to be made relatively large to obtain acceptable channel-to-channel crosstalk performance. The wide channel spacing results in is poor spectral efficiency. Spectral efficiency is a measure of how well available bandwidth is used to transmit required data. Specifically, spectral efficiency is the ratio of bit rate to channel spacing.

Finally, temperature sensitivity and mechanical tolerances make the design of conventional DWDM multiplexers and/or demultiplexers challenging, especially when the channel spacing is less than approximately 200 Gigahertz (GHz).

Thus, what is needed is an optical mux/demux having acceptable crosstalk performance at the channel spacing of modern DWDM optical transmission systems, e.g., 50 GHz, and additionally having a flat frequency response in the pass band to minimize distortion of the information signal and, hence, the bit error rate.

### SUMMARY OF THE INVENTION

The invention provides an optical multiplexer/demultiplexer that comprises an input/output channel array, a diffractive element, an arraying device and a converging element. The input/output channel array is located adjacent an optical axis and includes input/output channels arrayed in a first direction, orthogonal to the optical axis, at a predetermined pitch. The diffractive element is arranged to receive light from the input/output channel array at a location separated from the input/output channel array along the optical axis. The diffractive element diffracts the light to array the light wavelength-dependently in a second direction, different from the first direction. The arraying device receives light diffracted by the diffractive element and arrays the light in the first direction at a pitch equivalent to the predetermined pitch. The converging element is located along the optical axis between the diffractive element and either or both the arraying device and the input/output channel array.

The invention additionally provides a method for demultiplexing a multi-wavelength optical signal. In the method, the multi-wavelength optical signal is received and is wavelength-dependently separated into single optical signals arrayed in a first direction. The single optical signals have different wavelengths. The single optical signals are wavelength-independently arrayed in a second direction, different from the first direction. The arraying in the first direction is wavelength-dependently reversed and the single optical signals arrayed in the second direction are individually output.

Finally, the invention provides a method for multiplexing single optical signals to form a multi-wavelength optical signal. In the method, the single optical signals are received arrayed in a first direction. The single optical signals have different wavelengths. The single optical signals are wavelength-dependently arrayed in a second direction, different from the first direction. The arraying in the first direction is wavelength-independently reversed. The arraying in the second direction is wavelength-dependently reversed to spatially overlap the single optical signals to form the single multi-wavelength optical signal and the multi-wavelength optical signal is output.

The optical multiplexer/demultiplexer, the optical demultiplexing method and the optical multiplexing method provided by the invention have a filter shape has a flat frequency response in the pass band, so that the single optical signals are not subject to distortion. Thus, the invention provides a low BER when an information signal is recovered from each single optical signal. In addition, the filter shape has a steep slope in the stop band. This allows the width of the spectral gaps between adjacent channels to be minimized without unacceptable cross talk between the channels. Hence, invention maximizes usage of the bandwidth of the optical communication system.

### BRIEF DESCRIPTION OF THE DRAWINGS

The invention can be better understood with reference to the following drawings. The components of the drawings are not necessarily to scale. Emphasis is instead placed upon clearly illustrating the invention. Moreover, like reference numerals designate corresponding parts throughout the several views.

FIG. 1 is a block diagram illustrating a conventional optical communication system using wavelength division multiplexing.

FIG. 2 is a graph illustrating the Gaussian filter responses of an example of a conventional AWG-based optical mux/demux FIG. 3A is a schematic side view of a optical mux/demux according to the invention operating as a demultiplexer.

FIG. 3B is a schematic top view of the optical mux/demux shown in FIG. 3A.

FIG. 4A is a schematic side view of the optical mux/demux according to the invention operating as a multiplexer.

FIG. 4B is schematic top view of the optical mux/demux shown in FIG. 4A.

FIGS. 5A, 5B and 5C are respectively a side view, a front view and a top view of a first embodiment of the roof prism array of the optical mux/demux shown in FIG. 3A.

FIGS. 5A, 5B and 5C are respectively a side view, a front view and a top view of a second embodiment of the roof prism array of the optical mux/demux shown in FIG. 3A.

FIG. 6 is a schematic diagram illustrating spreading of the beam of one of the single optical signals in the respective roof prism of the optical mux/demux shown in FIG. 3A.

FIG. 7 is a graph illustrating the filter response of an example of the optical mux/demux shown in FIG. 3A.

FIG. 8A is a flowchart showing a first demultiplexing method according to the invention.

FIG. 8B is a flowchart showing a second demultiplexing method according to the invention.

FIG. 9A is a flowchart showing a first multiplexing method according to the invention.

FIG. 9B is a flowchart showing a second multiplexing method according to the invention.

FIGS. 10A and 10B are schematic diagrams illustrating examples of alternative arraying devices.

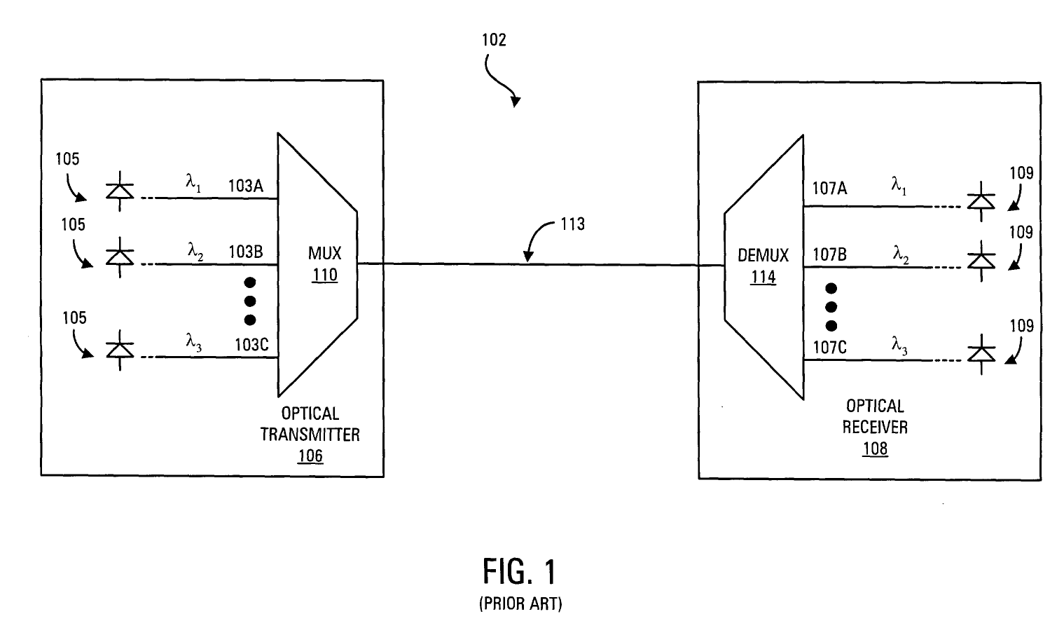

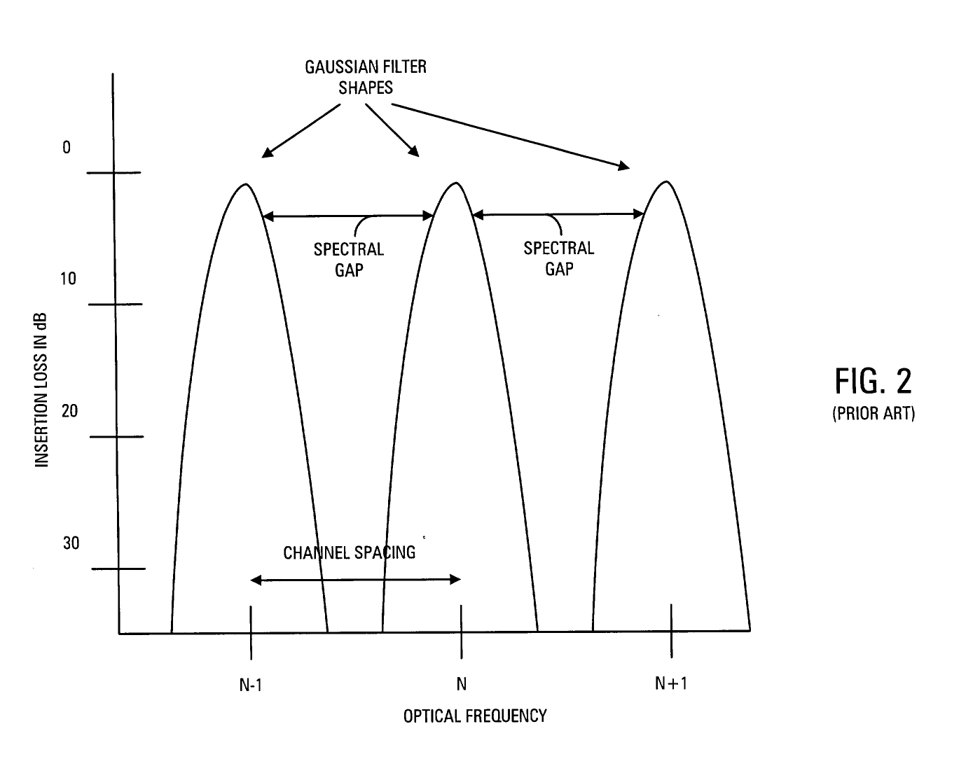

### DETAILED DESCRIPTION OF THE INVENTION

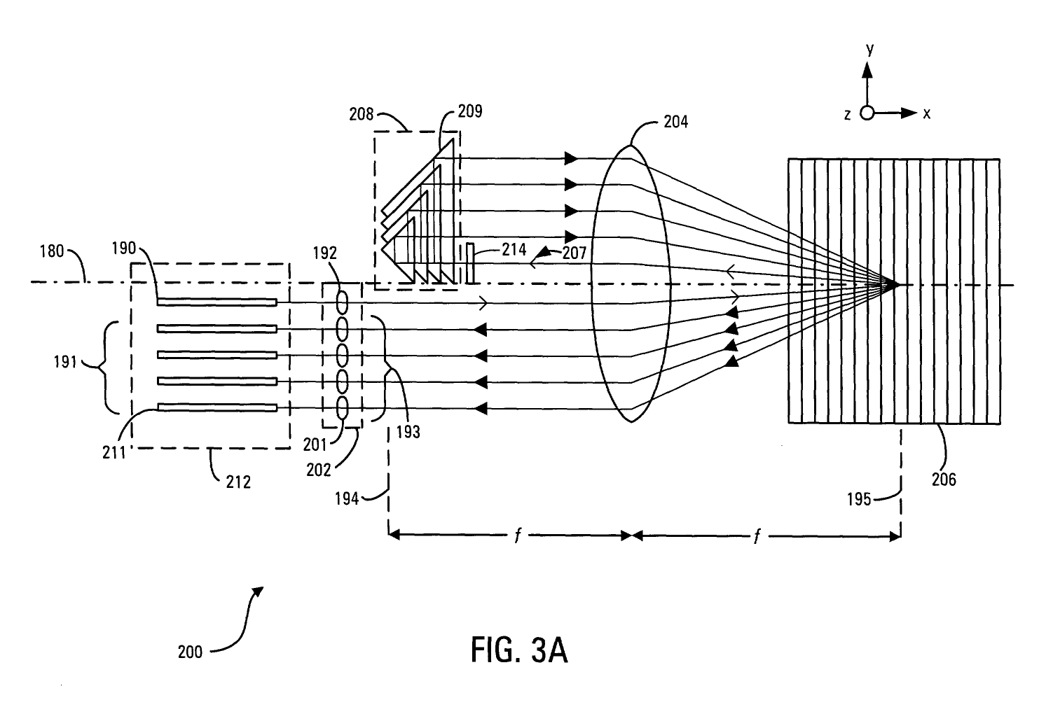

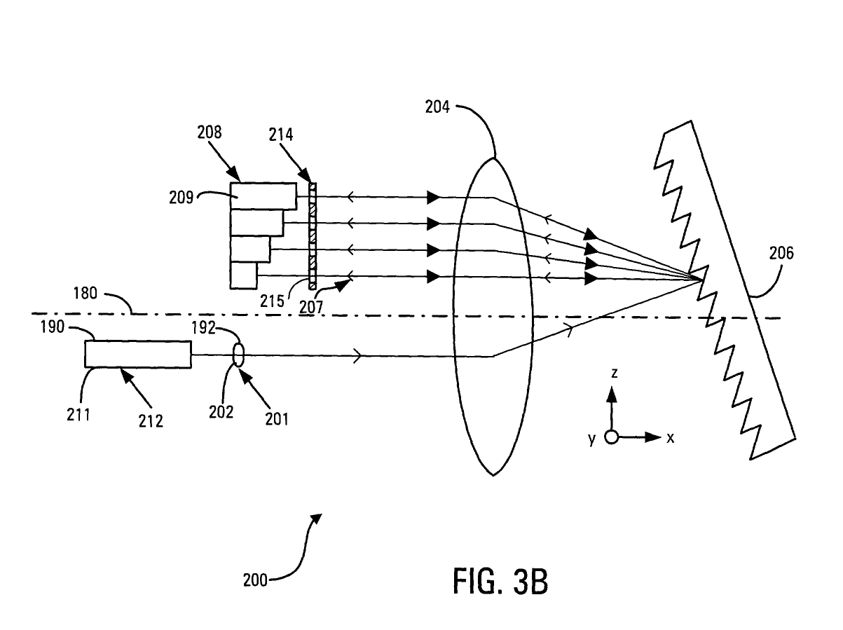

Referring now to the drawings, in which like reference numerals designate corresponding parts throughout the drawings, FIGS. 3A and 3B show an example 200 of an optical mux/demux according to the invention operating as a demultiplexer. Optical mux/demux 200 has a flat amplitude response in the filter pass band and a steeply-falling amplitude response in the stop band. The flat in-band response minimizes distortion of the optical signals while the steeply-falling response in the stop band provides low cross-talk and a high spectral efficiency, as will be described further below.

To simplify the drawings and related description, FIGS. 3A and 3B show a four-channel example of optical mux/demux 200. This example is structured to multiplex or to demultiplex a multi-wavelength optical signal composed of no more than four single optical signals having a different wavelengths. Embodiments of optical mux/demux 200 having substantially more than four channels, as is typical in optical multiplexers/demultiplexers, will be described below. In this disclosure, m denotes the number of channels.

Turning first to FIG. 3A, the optical mux/demux 200 is composed of an I/O channel array 212, a microlens array 202, a lens 204, a diffraction grating 206 and a roof prism array 208. Also shown in FIG. 3A is an optional spatial filter 214.

I/O channel array 212 is composed of m+1 I/O channels 211 arrayed in the y-direction. The I/O channel array is located offset in both the −y-direction and the −z-direction from an optical axis 180. Optical fibers constitute the I/O channels in the example shown. Optical waveguides may alternatively be used as the I/O channels.

Of the (m+1) I/O channels 211 constituting I/O channel array 212, the one I/O channel 190 differs in function from the m I/O channels 191. The functions of I/O channels 190 and 191, respectively, depend on whether the optical mux/demux 200 is operating as a multiplexer or as a demultiplexer. In the demultiplexer shown in FIG. 3A, I/O channel 190 is an input channel through which optical mux/demux 200 receives the multi-wavelength optical signal and each of I/O channels 191 is an output channel through which the optical mux/demux outputs one of the single optical signals demultiplexed from the multi-wavelength optical signal.

Microlens array 202 is composed of (m+1) microlenses 201 arrayed in the y-direction at a pitch corresponding to that of I/O channels 211 constituting I/O channel array 212. Each microlens re-images the light output by a respective one of I/O channels 211 on first focal plane 194 of lens 204 or alternatively re-images light focused in first focal plane 194 by lens 204 on a respective one of I/O channels 211.

Microlens array 202 matches the divergence of the beams input to and output by the channels constituting I/O array 212 to the numerical aperture of lens 204. Specifically, the microlens array allows the numerical aperture to be reduced (larger f-number), which simplifies the design of the lens. Since the beams input to and output by the I/O array have a fixed divergence, a telescope using conventional spherical optics can alternatively be used to double the beam spot size from 5 μm to 10 μm to reduce the beam divergence. However, microlens array 202 allows the channel spacing of the I/O channels 211 and the spot size to be varied independently.

Of the (m+1) microlenses constituting microlens array 212, microlens 192 performs a different one of the functions just described from the m microlenses 193, depending on whether the optical mux/demux 200 is operating as a multiplexer or as a demultiplexer. In the demultiplexer shown in FIG. 3A, microlens 192 re-images the multi-wavelength optical signal received via I/O channel 190 on first focal plane 194 of lens 204 and each of the m microlenses 193 re-images one of the single optical signals focused in first focal plane 194 by lens 204 on a respective one of I/O channels 191.

Diffraction grating 206 is located on optical axis 180 in a second focal plane 195 of lens 204. Second focal plane 195 is on the opposite side of the lens from first focal plane 194. The lines of diffraction grating are oriented in the y-direction.

Roof prism array 208 is located near first focal plane 194 of lens 204 and is offset in both the +y-direction and the +z-direction from optical axis 180. Specifically, roof prism array 208 is located and the roof prism array is configured so that the focal point of a parallel beam converged by lens 204 is located mid-way along the optical path through each of the m roof prisms 209 that constitute the roof prism array. In roof prism array 208, roof prisms 209 are arrayed in the z-direction. The roof prisms are arranged to receive light from lens 204 and are structured to return such light to the lens. The roof prism array returns the light to the lens displaced in the +y-direction relative to the light received from the lens. The roof prism array displaces the light received from the lens by a different distance in the +y-direction. The difference in the y-direction displacement between adjacent ones of the of the light corresponds to the pitch of I/O channel array 212, i.e., the distance in the y-direction between adjacent ones of I/O channels 211 constituting the I/O channel array.

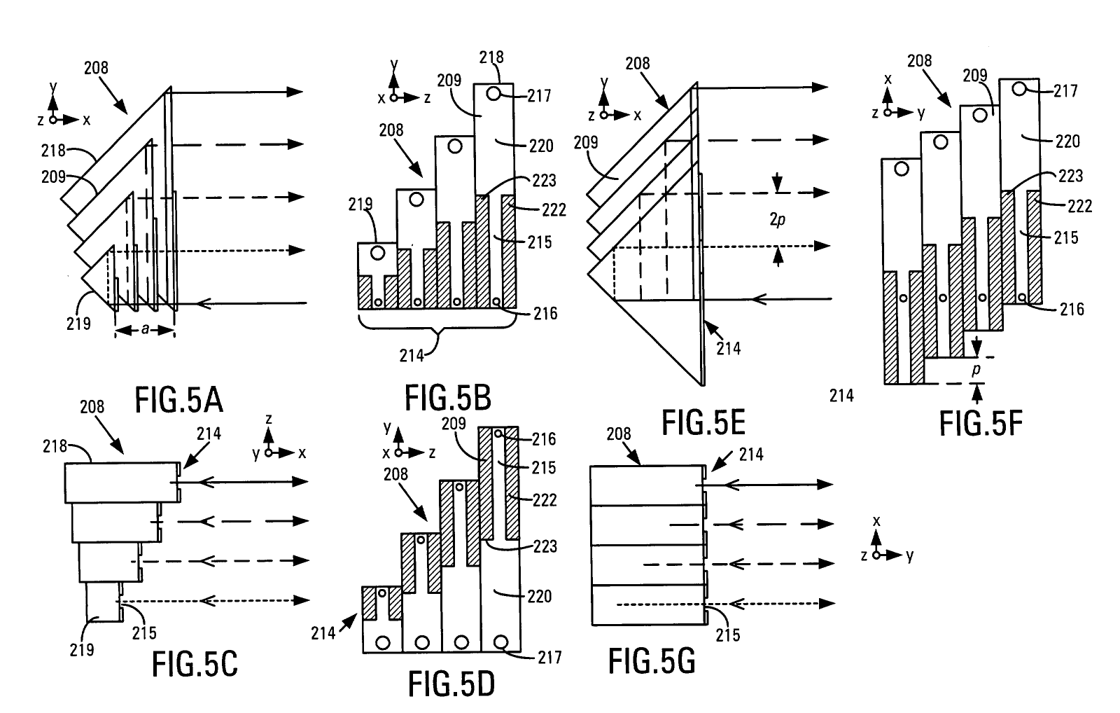

The number of roof prisms 209 in roof prism array 208 is equal to the number of channels that the optical mux/demux 200 is designed to multiplex or demultiplex. However, roof prism array 208 may be composed of more roof prisms than the number of channels. In the four-channel example shown in FIGS. 3A and 3B, roof prism array 208 is an array of four individual roof prisms 209. Roof prism array 208 will be described in further detail below with reference to FIGS. 5A-5G.

Optical mux/demux 200 is shown in FIG. 3A as being additionally composed of a spatial filter 214 located between lens 204 and roof prism array 208. In the example shown, the spatial filter is composed of slits 215 (FIG. 3B) arrayed in the z-direction and located in the path of light passing from lens 204 to roof prism array 208. Thus, in the demultiplexer shown in FIG. 3A, exemplary beam 207 passes through one of the slits constituting the spatial filter.

Slits 215 constituting spatial filter 214 have a width, i.e., dimension in the z-direction, less than the width, i.e., dimension in the z-direction, of roof prisms 209 constituting roof prism array 208. The relationship between the width of roof prisms 209, the width of slits 215 and the spot size of the single optical signals at roof prism array 208 will be described in detail below.

In the example shown in FIG. 3A, spatial filter 214 is shown as an element independent of roof prism array 208. The spatial filter is preferably located as close as possible to the roof prism array, so the spatial filter may be supported by the roof prism array or, as in the examples to be described below with reference to FIGS. 5A-5G, by the individual roof prisms 209.

Spatial filter 214 reduces cross-talk between the single optical signals constituting the multi-wavelength optical signal. Cross-talk becomes problematical when the position of a given single optical signals deviates significantly in the z-direction from the widthwise center of respective roof prism 209 constituting roof prism array 208. Manufacturing tolerances, variations due to environmental changes and/or static or dynamic differences in the wavelengths of the single optical signals from their respective channel center wavelengths can cause such a deviation. A widthwise positional deviation can cause at least part of the single optical signal to enter the adjacent roof prism 209, and consequently be displaced by the wrong distance in the y-direction. This causes the part of the single optical signal enter the wrong I/O channel of I/O channel array 212. The single optical signal entering the wrong I/O channel causes crosstalk.

In embodiments and applications of optical mux/demux 200 in which the single optical signals do not deviate significantly in the z-direction from the widthwise centers of the respective roof prisms 209, acceptable cross-talk performance can be obtained with spatial filter 214 omitted.

FIGS. 5A, 5B and 5C are enlarged views of a first embodiment of roof prism array 208. This embodiment is also shown in FIG. 3A. Each of the single optical signals is received from lens 204 by a different one of roof prisms 209 constituting roof prism array 208 and is reflected back towards the lens displaced by a different distance in the y-direction. In this embodiment, the roof prism array is structured so that the surface 220 that constitutes the hypotenuse of each roof prism 209 has a different length. Surface 220 will be called the hypotenuse surface of the roof prism. The dimension of the hypotenuse surface in the y-direction will be called the hypotenuse length of the roof prism. The hypotenuse length of a given roof prism determines the distance in the y-direction by which the roof prism displaces the respective single optical signal. The different hypotenuse lengths of roof prisms 209 cause the roof prism array to spatially separate the single optical signals by a predetermined distance in the y-direction, as shown in FIG. 5A, while maintaining the spatial separation of the single optical signals in the z-direction, as shown in FIG. 5C. Thus, after passing through the roof prism array, the single optical signals are arrayed both in the y-direction and in the z-direction. The roof prism array is structured such that the component in the y-direction of the separation between the single optical signals is equal to the pitch of I/O channel array 212, i.e., the separation in the y-direction between I/O channels 211 constituting the I/O array.

FIG. 5B shows the locations of the spots 216 into which the single optical signals are focused on the hypotenuse surfaces 220 of the roof prisms 209 in relation to the widths of the roof prisms and slits 215 constituting spatial filter 214. The spot sizes of the spots are enlarged to enable them to be seen in the drawing. FIG. 5B also shows the locations of the spots 217 corresponding to the single optical signals exiting the hypotenuse surfaces of the roof prisms 209. The spot sizes of the spots 217 are also enlarged to enable them to be seen in the drawing.

FIGS. 5B and 5C show an embodiment of spatial filter 214 in which the spatial filter is divided into elements each of which is supported by a corresponding one of roof prisms 209. In such an embodiment, the spatial filter element is composed of a patterned layer of metal deposited on part of the hypotenuse surface 220 of the roof prism. In the example shown, the metal pattern supported by hypotenuse surface 220 of largest roof prism 218 is composed of metal portions 222 and 223 that collectively define slit 215 of the spatial filter element. The slit is centered in the z-direction on the width of hypotenuse surface 220. Spatial filter 214 does not extend in the y-direction to the part of hypotenuse surface 220 from which the single optical signals exit roof prism 209. The spatial filter elements supported by the other roof prisms shown are similarly structured. Opaque materials capable of deposition on a surface of a roof prism may be used instead of metal to define the elements of the spatial filter.

In embodiments of optical mux/demux 200 specifically configured for operation as a multiplexer, the elements of spatial filter 214 may be located in the alternative positions shown in FIG. 5D.

FIGS. 5E-5G show a second embodiment of roof prism array 208 in which roof prisms 219 all have the same hypotenuse length and are aligned in the roof prism array progressively offset from one another in the y-direction by a distance equal to one-half of the channel spacing. An offset of p between one roof prism and another in the y-direction causes the displacement in the y-direction between the single optical signals reflected by the roof prisms to differ by 2p. Thus, an offset of 125 μm between adjacent roof prisms results in a difference in beam displacement of 250 μm. In an exemplary embodiment, each of the roof prisms 209 had a hypotenuse length of 10.125 mm and a width of 250 μm.

The embodiment of roof prism array 208 shown in FIGS. 5E-5G may be fabricated by cutting a large roof prism of the requisite dimensions into slices 250 μm thick. The slices are then attached to one another offset from one another by an offset of 125 μm in the y-direction, as described above.

Operation of optical mux/demux 200 as a demultiplexer will now be described initially with reference to FIG. 3A. A multi-wavelength optical signal is received via I/O channel 190, which constitutes part of I/O channel array 212. The multi-wavelength optical signal passes to micro lens 192 associated with I/O channel 190. Micro lens 192 is one of the microlenses 201 constituting micro lens array 202.

Micro lens 192 re-images the multi-wavelength optical signal received via I/O channel 190 on first focal plane 194 of lens 204. Lens 204 collimates light traveling towards diffraction grating 206, and focuses light received from diffraction grating 206, as will be described below. Although lens 204 is shown as a single, bi-convex lens, a multi-element converging lens is used as lens 204 in practical embodiments to reduce common optical aberrations. Such multi-element lens may include one or more diverging elements to reduce the overall length of the optical mux/demux 200.

Lens 204 collimates the multi-wavelength optical signal diverging from first focal plane 194 on which it has been focused by micro lens 192. The multi-wavelength optical signal collimated by the lens passes to diffraction grating 206. The collimated illuminates a substantial area of diffraction grating 206, which enables the diffraction grating to have a high diffraction efficiency.

Diffraction grating 206 diffracts the multi-wavelength optical signal. This angularly separates the multi-wavelength optical signal into its constituent single optical signals. The diffraction grating 206 diffracts each single optical signal at a diffraction angle that depends on the wavelength of the single optical signal. Thus, since the single optical signals have different wavelengths, each single optical signal is diffracted at a different diffraction angle. Diffraction grating 206 is reflective, so that the single optical signals diffracted at different diffraction angles by the diffraction grating return to and pass through lens 204. After the single optical signals diffracted by the diffraction grating pass through the lens, they become spatially arrayed in a first direction, namely, in the z-direction.

FIG. 3A is a side view of optical mux/demux 200, so it appears as if one single optical signal 207 returns to and passes through lens 204 after diffraction by diffraction grating 206. However, in the example in which the multi-wavelength optical signal is composed of four single optical signals, diffraction grating 206 diffracts the four single optical signals at different diffraction angles. The four single optical signals all lie in the x-z plane after diffraction, so that the single optical signal 207 hides the remaining three single optical signals in FIG. 3A.

FIG. 3B is a top view of optical mux/demux 200 that better illustrates the four single optical signals resulting from diffraction grating 206 diffracting the multi-wavelength optical signal. These single optical signals are indicated by open arrows. These single optical signals are in fact hidden by the single optical signals, indicated by closed arrows, returning from roof prism array 208 to the diffraction grating. Passing through lens 204 arrays in the z-direction the single optical signals angularly separated by the diffraction grating. Single optical signal 207 is identified in FIG. 3B for the purpose of comparison to FIG. 3A.

Lens 204 focuses each of the single optical signals received from diffraction grating 206 onto a different one of roof prisms 209 constituting roof prism array 208. While the single optical signals are collimated and are partially overlaid entering lens 204, at roof prism array 208, the single optical signals have been focused by lens 204 to small spots having a spot size of about 20 μm. As will be described in detail below, the spot size of the spots is a fraction of the width of the roof prisms and the width of the slits 215 constituting spatial filter 214. The spots are arrayed in the z-direction at the roof prism array, as shown in FIG. 3B, are spatially separated from one another in the z-direction by a distance equal to the width of roof prisms 209 and each is nominally centered widthwise on the respective one of the roof prisms. As a result, each of the single optical signals passes through a different one of roof prisms 209.

Returning now to FIG. 3A, the single optical signals exit from roof prism array 208 arrayed in the y-direction in addition to being arrayed in the z-direction. A more detailed description of the arraying provided by roof prism array 208 is set forth below. The single optical signals exiting roof prism array 208 travel in the +x-direction towards lens 204. The direction of travel of the single optical signals is parallel to, opposite to and offset in the y-direction from, their direction prior to arraying by the roof prism array. Lens 204 collimates the diverging beams of the single optical signals received from the roof prism array 208.

The single optical signals then pass from lens 204 to diffraction grating 206. The diffraction grating diffracts the single optical signals a second time and reflects the single optical signals back toward lens 204. The second diffraction by diffraction grating 206 reverses the angular dispersal that resulted from the first diffraction and, hence, reverses the arraying of the single optical signals in the z-direction. However, the single optical signals remain arrayed in the y-direction.

Diffraction grating 206 reflects the single optical signals arrayed only in the y-direction towards lens 204. Lens 204 focuses each of the single optical signals received from the diffracted grating 206 in first focal plane 194 of the lens and at a point corresponding to a different one of the m micro lenses 193 that constitute part of micro lens array 202. Micro lens 192 does not receive any of the single optical signals from lens 204. Each of micro lenses 193 re-images one of the single optical signals received from lens 204 on a respective one of the m I/O channels 191 constituting part of I/O channel array 212. Each single optical signal is re-imaged in a manner that efficiently couples the single optical signal into the respective I/O channel 211.

The single output signals are then individually output via respective ones of I/O channels 191.

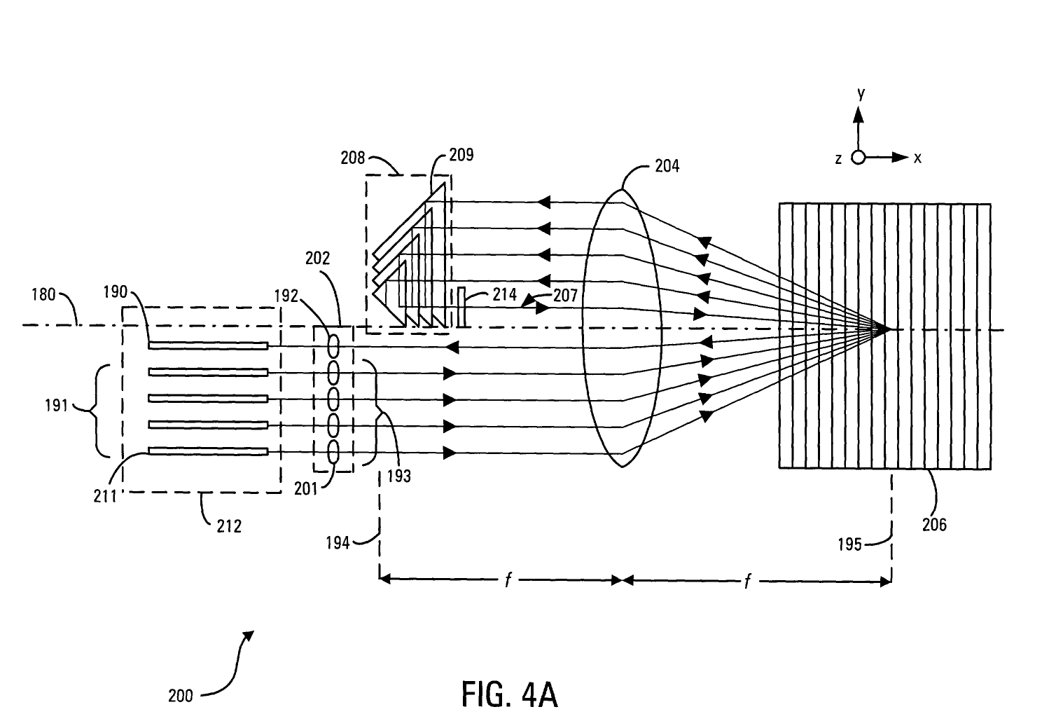

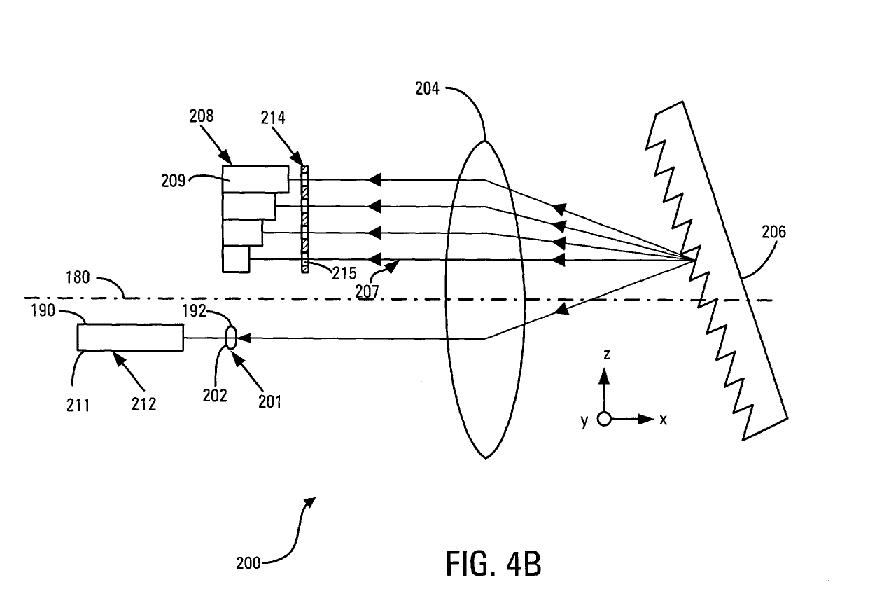

FIGS. 4A and 4B show an embodiment of optical mux/demux 200 operating as an optical multiplexer. It should be noted that the structure of optical mux/demux of FIGS. 4A and 4B is the same as that of optical mux/demux 200 operating as a demultiplexer shown in FIGS. 3A and 3B. However, the functions of I/O channels 190 and 191 and of microlenses 192 and 193 differ from the functions of these elements in the demultiplexer. Moreover, the position of spatial filter 214 may be changed from the position shown, as described above with reference to FIG. 5D.

Single optical signals are received via m respective I/O channels 191 that constitute part of I/O channel array 212. The I/O channel array arrays the single optical signals in the y-direction. The spacing in the y-direction between the single optical signals is defined by the pitch of the I/O channel array. The single optical signals pass to respective ones of micro lenses 193 that constitute part of micro lens array 202. The micro lenses focus the single optical signals in first focal plane 194 of lens 204. Lens 204 collimates the diverging beams of the single optical signals, and the collimated single optical signals pass to diffraction grating 206.

Diffraction grating 206 diffracts the single optical signals through angles dependent on their wavelengths and reflects the single optical signals back towards lens 204. Passing through lens 204 arrays the single optical signals in the z-direction in addition to their arraying in the y-direction. The lens additionally focuses the single optical signals on respective ones of the roof prisms 209 constituting roof prism array 208. The single optical signals pass through roof prism array 208. The difference in y-direction displacement between adjacent ones of the roof prisms of the roof prism array corresponds to the pitch of I/O array 212. As a result, all of the single optical signals exit from the roof prism in the same x-z plane. Thus, the roof prism array has wavelength-independently reversed the arraying of the single optical signals in the y-direction. The single optical signals exit the roof prism array arrayed only in the z-direction and traveling in the +x-direction towards lens 204.

Lens 204 collimates the single optical signals received from roof prism array 208. The single optical signals then pass from lens 204 to diffraction grating 206. The diffraction grating diffracts the single optical signals a second time and reflects the single optical signals back toward lens 204. The second diffraction by diffraction grating 206 reverses the angular dispersal that resulted from the first diffraction and, hence, reverses the arraying of the single optical signals in the z-direction. Reversing the arraying of the single optical signals in the z-direction spatially overlays the single optical signals to form a multi-wavelength optical signal. Lens 204 then focuses the multi-wavelength optical signal at a point in first focal plane 194 aligned with microlens 192, an element of micro lens array 202. Micro lens 192 re-images the multi-wavelength optical signal on I/O channel 190, an element of I/O channel array 212.

The multi-wavelength optical signal is then output via I/O channel 190.

In this disclosure, the term spot size is used to denote the radius of a single optical signal and is defined as the radius of a monochromatic single optical signal at which the power density falls to 1/e² of the peak power density. The term spot waist size denotes the minimum spot size to which the single optical signal is focused as it enters the roof prism array.

The extent to which optical mux/demux 200 can be miniaturized is limited in one aspect by diffraction that causes lateral spreading of the single optical signals as they pass through roof prism array 208. Lateral spreading of the single optical signals defines a minimum width of roof prisms 209 constituting the roof prism array. Proper selection of the spot waist size of the single optical signals at the roof prism array minimizes beam diffraction. As a single optical signal passes through its corresponding roof prism, it should spread laterally to a width less than the width of the roof prism. Otherwise, the roof prism will clip the single optical signal. Clipping is undesirable as it reduces the intensity of the single optical signal and can cause cross talk.

Clipping is avoided by an appropriate choice of the spot waist size of the single optical signal in relation to the dimensions of the roof prism. An example of a process for determining the minimum spot size selection will now be described with reference to an 80-channel embodiment of optical mux/demux 200. In such embodiment, I/O channel array 212 is composed of 80 I/O channels 191. Of the 80 I/O channels, 40 are arrayed in the +y direction and 40 are arrayed in the −y-direction relative to I/O channel 190. Additionally, roof prism array 208 is composed of at least 80 roof prisms 209. It should be noted that the following is an example and that other methods and systems for selecting the spot waist size may be used.

The filter shape of optical mux/demux 200 is determined by three parameters, namely, the spot waist size of the single optical signals at the roof prism array 208, the width of slits 215 and the channel spacing. The channel spacing is the spacing in the z-direction between the single optical signals at the roof prism array. The channel spacing corresponds to the width, i.e., the dimension in the z-direction, of the roof prisms 209. Also, the example shown has a magnification of one, so the channel spacing is also equal to the pitch in the y-direction of I/O channel array 212. At other magnifications, the channel spacing corresponds to the pitch in the y-direction of the I/O channel array.

Setting the ratios between spot size, slit width and channel spacing to 1:5:8 provides the optical mux/demux 200 with a filter response having stop band slope sufficiently steep for operation with a channel spacing of 50 GHz and additionally provides a flat-topped response in the filter pass band.

The design of roof prism array 208 will now be described with reference to the simplified example shown in FIGS. 5A-5C. In roof prism array, largest roof prism 218 has the largest hypotenuse length and the largest length of the portion of the optical path disposed in the y-direction and smallest roof prism 219 has the smallest hypotenuse length and the smallest length of the portion of the optical path disposed in the y-direction. The remaining roof prisms have hypotenuse lengths and optical path lengths intermediate between those of the largest and smallest roof prisms. In some embodiments of the roof prism array 208, the roof prisms have equal hypotenuse lengths, as will be described below with reference to FIGS. 5E-5G.

Using the 1:5:8 ratios described above, in an 80-channel embodiment of optical mux/demux 200, the maximum length of the optical path disposed in the y-direction in largest roof prism 218 is 320 times (8×40) the spot size. In an embodiment in which the channel spacing is equal to the pitch of I/O array 212, this corresponds to 40 times the pitch of the I/O array.

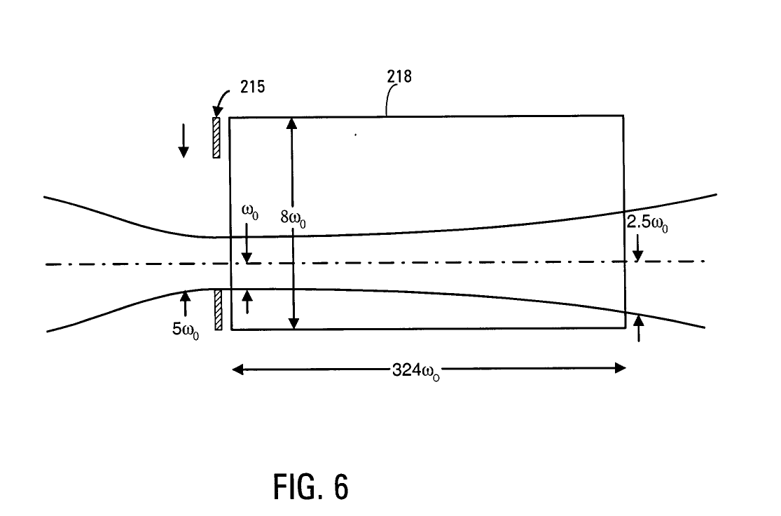

Calculation of the minimum size of largest roof prism 218 will now be described with reference to FIG. 6. FIG. 6 illustrates the way in which the single optical signal spreads due to diffraction as it passes through largest roof prism 218. The single optical signals passing through the other roof prisms of roof prism array 208 spread similarly, but less. The optical path through roof prism 218 is shown unfolded to simplify the drawing. Slit 215 is located immediately in front of the largest roof prism. For the purpose of this calculation, the single optical signal is composed of monochromatic light having a wavelength corresponding to the center frequency of the longest-wavelength channel, i.e., the channel corresponding to largest roof prism 218.

For the purpose of simplifying the following calculation, the single optical signal shown is focused by lens 204 to a minimum spot size at slit 215. The minimum spot size is the spot waist size and is denoted by the symbol ωₒ. The slit has a width of 5 ωₒ and is centered in the z-direction relative to the width of largest roof prism 218. The width of each of roof prisms 209 is 8 ωₒ. In a practical embodiment, lens 204 would focus the single optical signal at a point half-way along the optical path shown.

The length of the part of the optical path disposed in the y-direction in largest roof prism 218 is equal to 320 times the spot waist size ωₒ, as noted above. This is equal to the separation in the y-direction between the single optical signal returned to lens 204 by largest roof prism 218 and the single optical signal returned to the lens by smallest roof prism 219. Clipping of the single optical signal is avoided when the center of the single optical signal is located a distance ωₒ, from one edge of slit 215 and the edge of the single optical signal does not intersect the nearest edge of the roof prism after the single optical signal has propagated a distance of 320 ωₒ in the y-direction through the roof prism. To account for the portions of the optical path in the x-direction, assumed each to have a length of 2 ωₒ a propagation distance of 324 ωₒ will be used in the following calculations.

Referring additionally to FIG. 3A, dependence of the spot size ω(y) on defocus y is given by equation (1):

$$ω ( y ) = {ω}_{0} {\sqrt{1 + ( \frac{y}{{z}_{r}} )}}^{2} \qquad ( 1 )$$

where zᵣ is the Rayleigh range, defined by equation (2).

$${z}_{r} = \frac{π n {ω}_{0}^{2}}{λ} \qquad ( 2 )$$

where n is the refractive index of largest roof prism 218 and λ is the wavelength of the monochromatic single optical signal in vacuo. After propagating a distance of 324 times the spot waist size through largest roof prism 218, the spot size should not increase to more than 2.5 ωₒ if clipping is to be avoided. Setting y=324 ωₒ and ω(y)=2.5 ωₒ in equation (1) provides equation (3):

324 ωₒ=229zᵣ (3)

Substituting equation (2) into equation (3), the spot waist size in the above-described exemplary optical mux/demux is given by equation (4).

$${ω}_{o} = \frac{141.5 λ}{π n} \qquad ( 4 )$$

There is a substantial benefit to using a high refractive index (n) material for each roof prism 209. As an example, in an embodiment in which the roof prism is made of silicon, which has a refractive index (n) of 3.5, the spot waist size would be 19.9 μm. With a spot waist size of 19.9 μm, the minimum width of each of the roof prisms is 8×19.9 μm, which is approximately 160 μm. This is substantially less than 250 μm, which is the pitch of commercially-available fiber optic arrays suitable for use as I/O array 212.

An 80-channel embodiment of optical mux/demux 200 structured to incorporate a conventional, commercially-available fiber optic array as I/O array 212 will be described next. Such fiber optic array has a pitch of 250 μm, which, with a magnification of one, sets the channel spacing to 250 μm. With a channel spacing of 250 μm, the spot size is 31.25 μm and the slit width is 156.25 μm.

The angular dispersion of diffraction grating 206 is given by equation (5):

$$\frac{ⅆ β}{ⅆ λ} = \frac{2 tan β}{λ} \qquad ( 5 )$$

where β is the angle between the normal to diffraction grating 206 and the incident multi-wavelength optical signal. The relationship between the wavelength λ of the single optical signal, the angle β and the pitch d of diffraction grating 206 is defined by equation (6).

λ=2d sin β (6)

Lens 204 transforms the angular dispersion of the single optical signals to spatial arraying in the z-direction in accordance with the relationship shown by equation (7).

$$\frac{ⅆ z}{ⅆ λ} = f \frac{ⅆ β}{ⅆ λ} \qquad ( 7 )$$

where f is the focal length of lens 204. Substituting equation (6) into equation (5), and incorporating the result into equation (7) yields equation (8), which defines the focal length f of the lens 204:

$$f = \frac{δ z}{δ λ} d cos β \qquad ( 8 )$$

where δz is the channel spacing at roof prism array 208 and δλ is the channel wavelength spacing, e.g., about 0.4 nm in a DWDM system with a 50 GHz channel spacing.

Making the focal length f of lens 204 as short as possible minimizes the size of optical mux/demux 200. To minimize the focal length f the minimum pitch d consistent with low loss and low polarization dependence is selected. For example, a 600 lines/mm grating having a pitch d of 1.667 μm will give good results when used as diffraction grating 206. Diffraction gratings with pitches different from that exemplified may be used with a proportional change in the focal length of the lens 204. The value of β calculated from equation (6) is 27.71 degrees for a center wavelength of 1.55 μm. Substituting the above results into equation (8) gives a focal length f of lens 204 of 922 mm.

The spot size ω at lens 204, which is approximately the same as the spot size at diffraction grating 206, can be calculated from equation (1) to be 7.27 mm. To avoid power loss in optical mux/demux 200, the diameter of lens 204 should be greater than three times the spot size at the lens, i.e., greater than 21.8 mm. Diffraction grating 206 is approximately the same size as the lens 204 when corrected for the angle of incidence on the diffraction grating. In practice, to fulfill telecentricity requirements, the lens will be substantially larger than the minimum size just stated. The fiber optic array used as I/O array 212 has an overall length of about 20 mm in the y-direction, so that the lens diameter will be about 50 mm in practice.

In the embodiment of roof prism array 208 shown in FIGS. 5A-5C, the different optical path lengths in the y-direction are achieved by each roof prism 209 having a different hypotenuse length. The individual roof prisms are assembled to form the roof prism array with one of their apices adjacent their hypotenuse surfaces located in a common x-z plane and their hypotenuse surfaces staggered in the x-direction, as will be described below. In an example, the largest roof prism has a hypotenuse length of 10.125 mm, which corresponds to 324 ω₀, and the smallest roof prism has a hypotenuse length of 0.375 mm, which corresponds to 12 ω₀. All of the prisms have a width of 250 μm.

The roof prisms 209 are assembled to form roof prism array 208 with one of their apices adjacent their hypotenuse surfaces aligned in a common x-z plane and their hypotenuse surfaces offset from one another in the x-direction to make the lengths of the optical paths through all the roof prisms equal. This keeps all of the single optical signals in focus at I/O channel array 212. The offset a in the x-direction of smallest roof prism 219 relative to largest roof prism 218 is:

$$a = \frac{39 ( 320 {ω}_{0} )}{2 n} \qquad ( 9 )$$

in which 39 is the number of I/O channels 191 arrayed on one side of the I/O channel 190, minus one. 320 ω₀ is the largest optical path length in the y-direction, and is approximately equal to 10 mm. For silicon prisms and with the other parameters as defined above, the x-direction offset a of smallest roof prism 219 is 1.39 mm. The x-direction offsets of the remaining roof prisms of roof prism array 208 are distributed in equal increments between zero and 1.39 mm.

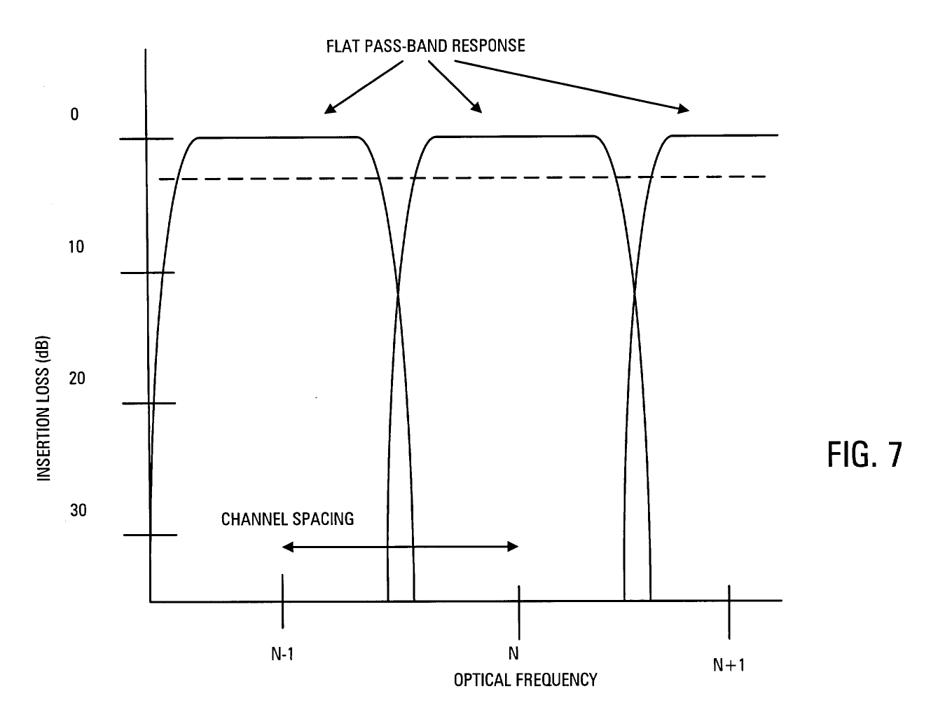

FIG. 7 is a graph showing an example of the spectral efficiency provided by optical mux/demux 200. In FIG. 7, the optical frequency of three of the single optical signals is plotted on the x-axis and the insertion loss of optical mux/demux 200 is plotted on the y-axis. The filter shape has a flat frequency response in the pass band, so that the single optical signal is not subject to distortion by passing through optical mux/demux 200. This provides a low BER when the information signal is recovered from the single optical signal. In addition, the filter has a steep slope in the stop band. This allows the width of the spectral gaps between adjacent channels to be minimized without unacceptable cross talk. Hence, optical mux/demux 200 maximizes usage of the bandwidth of the optical fiber.

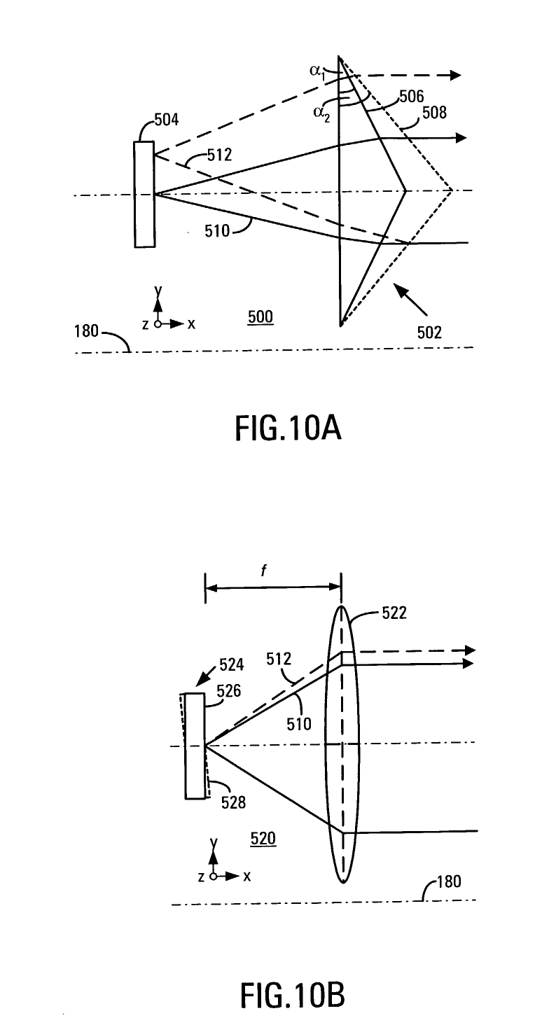

The optical mux/demux 200 has been described above with reference to examples in which lenses are used to re-image, collimate and focus the various optical signals, in which diffraction grating 206 is reflective, and in which roof prism array 208 is used to array the single optical signals in the y-direction or to reverse such arraying. Elements other than lenses, such as mirrors and diffractive optical elements, may be used instead of the lenses shown to re-image, collimate and focus the optical signals. Also, lens 204, shown as a single-element lens, may be composed of more than one element. Moreover, a transmissive diffraction grating may be used as diffraction grating 206. Finally, optical elements other than the roof prisms shown may be used to array the single optical signals in the y-direction and to reverse such arraying, as will be described below with reference to FIGS. 10A-10C. Light may exit such alternative optical elements in the same direction as that in which the light entered instead of being reflected back towards lens 204 as in the examples shown.

To reduce the size of optical mux/demux 200, the long air paths on opposite sides of lens 204 may be folded using reflective elements such as mirrors. Alternatively, a beam-expanding telescope with a focal length equivalent to that of lens 204 may used instead of lens 204.

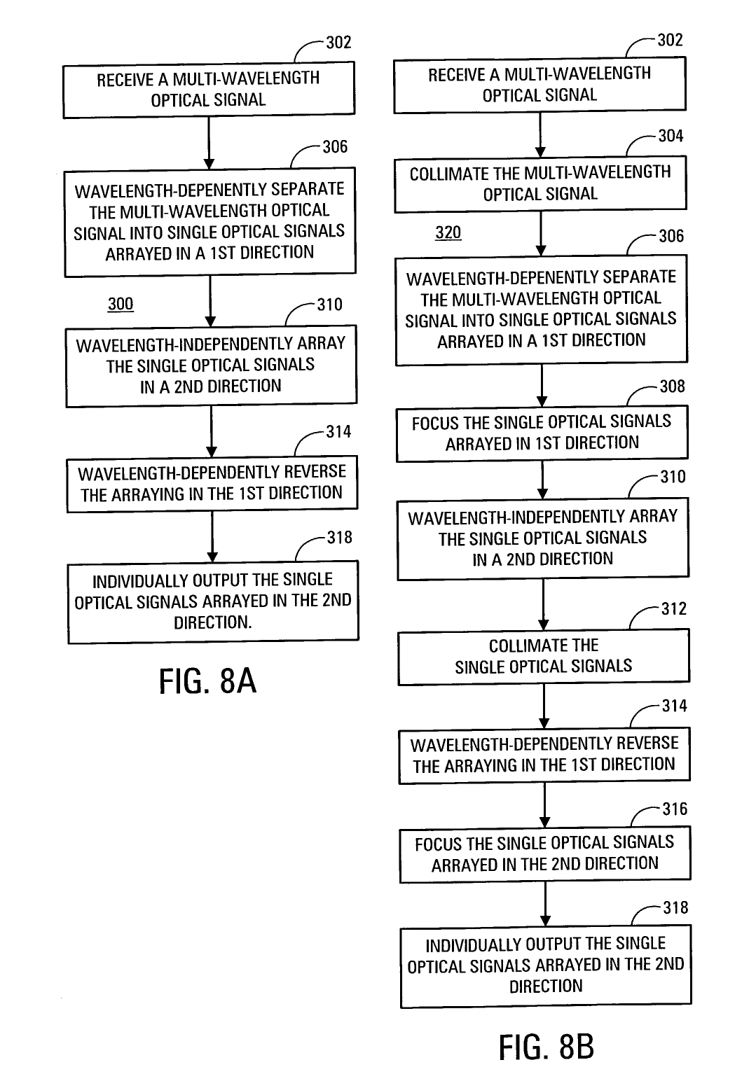

FIG. 8A is a flowchart illustrating a first method 300 in accordance with the invention for demultiplexing a multi-wavelength signal. With regard to the flowchart of FIG. 8A, and in the other flowcharts depicted in this disclosure, it should also be noted that in some implementations, the functions performed in the blocks may occur out of the order shown. For example, two blocks shown in succession may in fact be executed substantially concurrently, or the blocks may sometimes be executed in the reverse order.

In block 302, a multi-wavelength optical signal is received. In block 306, the multi-wavelength optical signal is wavelength-dependently separated into its constituent single optical signals arrayed in a first direction. Each of the single optical signals has a different wavelength. In block 310, the single optical signals are wavelength-independently arrayed in a second direction, different from the first direction. In block 314, the arraying of the single optical signals in the first direction is wavelength-dependently reversed, leaving the single optical signals arrayed in the second direction. In block 318, the single optical signals arrayed only in the second direction are individually output.

FIG. 8B is a flowchart illustrating a second method 320 in accordance with the invention for demultiplexing a multi-wavelength signal. In block 302, a multi-wavelength optical signal is received. In block 304, the multi-wavelength optical signal is collimated. In block 306, the multi-wavelength optical signal is wavelength-dependently separated into its constituent single optical signals arrayed in a first direction. Each of the single optical signals has a different wavelength. In block 308, the single optical signals arrayed in the first direction are focused. In block 310, the single optical signals are wavelength-independently arrayed in a second direction, different from the first direction.

In block 312, the single optical signals, arrayed in both the first direction and the second direction, are collimated. In block 314, the arraying of the single optical signals in the first direction is wavelength-dependently reversed, leaving the single optical signal arrayed in the second direction. In block 316, the single optical signals arrayed in the second direction are focused. In block 318, the optical signals arrayed only in the second direction are individually output.

The multi-wavelength optical signal received in block 302 may be re-imaged before being collimated in block 304. Moreover, the single optical signals arrayed in the second direction may be re-imaged before being individually output in block 318. The single optical signals arrayed in the first direction may be spatially filtered before or after being wavelength-independently arrayed in block 310. In the focusing performed in block 308, the spot size of the single optical signals is changed to a spot waist size at which each of the single optical signals is individually wavelength-independently arrayed. This prevents clipping of and cross talk between the single optical signals.

The methods 300 and 320 described in FIGS. 8A and 8B may be performed by the optical mux/demux 200 shown operating as a demultiplexer in FIGS. 3A and 3B.

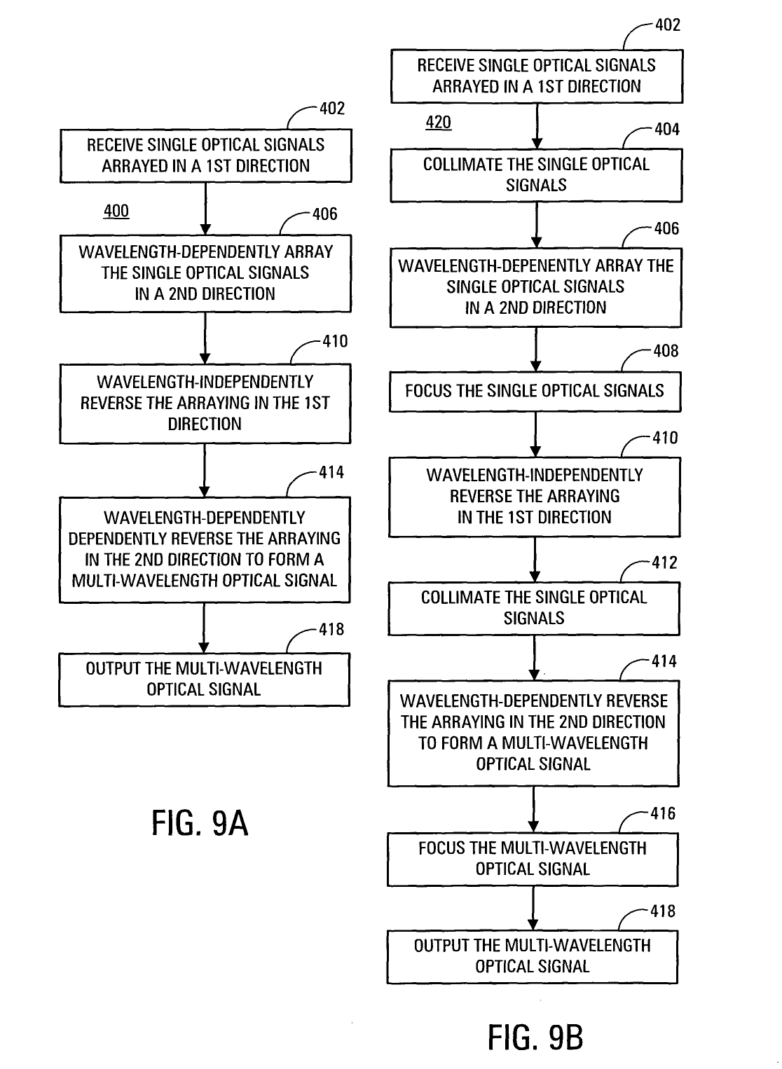

FIG. 9A is a flowchart illustrating a first method 400 in accordance with the invention for multiplexing single optical signals to form a multi-wavelength signal.

In block 402, single optical signals arrayed in a first direction are received. Each of the single optical signals has a different wavelength. In block 406, the single optical signals are wavelength-dependently arrayed in a second direction, different from the first direction. In block 410, the arraying of the single optical signals in the first direction is wavelength-independently reversed. In block 414, the arraying of the single optical signals in the second direction is wavelength-dependently reversed. This spatially overlaps the single optical signals to form a multi-wavelength optical signal. In block 418, the multi-wavelength optical signal is output.

FIG. 9B is a flowchart illustrating a second method 420 in accordance with the invention for multiplexing single optical signals to form a multi-wavelength signal. In block 402, the single optical signals arrayed in a first direction are received. Each of the single optical signals has a different wavelength. In block 404, the single optical signals are collimated. In block 406, the single optical signals are wavelength-dependently arrayed in a second direction. In block 408, the single optical signals arrayed in both the first direction and the second direction are focused. In block 410, the arraying of the single optical signals in the first direction is wavelength-independently reversed, leaving the single optical signals arrayed in the second direction.

In block 412, the single optical signals arrayed in the second direction are collimated. In block 414, the arraying of the single optical signals in the second direction is wavelength-dependently reversed. This spatially overlaps the single optical signals to form a multi-wavelength optical signal. In block 416, the multi-wavelength optical signal is focused. In block 418, the multi-wavelength optical signal is output.

The single optical signals received in block 402 may be re-imaged before being collimated in block 404. Moreover, the multi-wavelength optical signal focused in block 416 may be re-imaged before being output in block 418. The single optical signals arrayed in both the first direction and the second direction may be spatially filtered before their arraying in the first direction is reversed in block 410. Additionally or alternatively, the single optical signals arrayed in the second direction may be spatially filtered before being collimated in block 412. In the focusing performed in block 408, the spot size of the single optical signals is changed to a spot size at which the arraying of each of the single optical signals is individually reversed. This prevents clipping of and cross talk between the single optical signals.

The methods 400 and 420 described in FIGS. 9A and 9B may be performed by the optical mux/demux 200 shown operating as a multiplexer in FIGS. 4A and 4B.

In the optical mux/demux 200 described above, roof prism array 208 performs the function of receiving light diffracted by the diffractive element and arraying the light in the first direction at a pitch equivalent to the pitch of the input/output channel array. However, elements other than a roof prism array may be used to perform this function. For example, each roof prism of the roof prism array may be replaced by a pair of reflective surfaces located in positions equivalent to those of the reflective surfaces of the roof prism. A medium having a refractive index greater than unity may be located in the optical path between the reflective surfaces to reduce diffraction effects, as described above.

FIGS. 10A and 10B show examples of other arraying devices that may be used to perform the function of receiving light diffracted by the diffractive element and arraying the light in the first direction at a pitch equivalent to the pitch of the input/output channel array. These examples will now be described with reference to FIGS. 10A and 10B and with additional reference to FIG. 3A.

FIG. 10A shows arraying device 500 composed of prism array 502 and mirror 504. Prism array 502 is composed of one prism for each channel of the optical mux/demux. Each prism of the prism array has a thickness in the z-direction equal to the channel spacing, i.e., the spacing in the z-direction between the single optical signals. Each prism has a different prism angle α. The prisms of two exemplary channels are shown at 506 (solid line) and 508 (broken line).

The paths through arraying device 500 of the single optical signals 510 and 512 respectively aligned with prisms 506 and 508 are shown by a solid line and a broken line, respectively. The single optical signals are received from lens 204 arrayed in the z-direction. Single optical signal 512 is hidden by single optical signal 510. Single optical signal 510 passes through prism 506 and is refracted towards the optical axis 180 through an angle that depends on the prism angle α₁. Single optical signal 512 passes through prism 508 and is refracted towards the optical axis 180 through an angle that depends on the prism angle α₂, greater than prism angle α₁. Single optical signals 510 and 512 pass to mirror 504. Single optical signal 512 impinges on the mirror at a point offset in the y-direction from single optical signal 510 and with a greater angle of incidence. The mirror reflects the single optical signals back towards prisms 506 and 508, respectively. The single optical signals impinge on the prisms at points offset from one another in the y-direction. The prisms refract the respective single optical signals through angles that depend on their respective prisms. The single optical signals emerge from the respective prisms in a direction parallel to the axis 180 and arrayed in the y-direction.

The prism angles required to provide a given offset between the single optical signals for a given size and refractive index of the prisms of prism array 502 and a given distance of the prism array from mirror 504 can be calculated using simple optical calculations.

FIG. 10B shows an example 520 of an arraying device composed of a cylindrical converging element and a mirror array. In the arraying device 520, a cylindrical lens 522 with its axis disposed in the y-direction is used as the cylindrical converging element. Mirror array 524 is located in the focal plane of the cylindrical lens. Mirror array 524 is composed of one reflective surface for each channel of the optical mux/demux. The reflective surfaces of two exemplary channels are shown at 526 (solid line) and 528 (broken line). Each reflective surface is disposed at a different angle relative to the y-z plane. In the example shown, reflective surface 526 is disposed parallel to the y-z plane whereas reflective surface 526 is disposed at a non-zero angle relative to the y-z plane. Each reflective surface has a width, i.e., dimension in the z-direction, equal to the channel spacing.

The paths through arraying device 520 of the single optical signals 510 and 512 respectively aligned with reflective surfaces 526 and 528 of mirror array 524 are shown by a solid line and a broken line, respectively. The single optical signals are received from lens 204 arrayed in the z-direction. Single optical signal 512 is hidden by single optical signal 510. The single optical signals pass through cylindrical lens 522 and are refracted towards the optical axis 180. Single optical signals 510 and 512 pass to reflective surfaces 526 and 528, respectively, and are reflected by the reflective surfaces back towards cylindrical lens 522. Due to the different angles of the reflective surfaces, the single optical signals impinge on the cylindrical lens at points offset from one another in the y-direction. The cylindrical lens refracts the respective single optical signals through angles at which the single optical signals emerge from the lens in a direction parallel to the optical axis 180 and to one another, and arrayed in the y-direction.

The angles of the refractive surfaces required to provide a given offset between adjacent ones of the single optical signals for a given focal length of cylindrical lens 522 can be calculated using simple optical calculations.

This disclosure describes the invention in detail using illustrative embodiments. However, it is to be understood that the invention defined by the following claims is not limited to the precise embodiments described.

We claim:

1. An optical multiplexer/demultiplexer, comprising:
an input/output channel array located adjacent an optical axis, and including input/output channels arrayed in a first direction, orthogonal to the optical axis, at a predetermined pitch;
a diffractive element arranged to receive light from the input/output channel array at a location separated from the input/output channel array along the optical axis, and operating to diffract the light to array the light wavelength-dependently in a second direction, different from the first direction;
arraying means for receiving light diffracted by the diffractive element and for arraying the light in the first direction at a pitch equivalent to the predetermined pitch; and
a converging element located along the optical axis between the diffractive element and at least one of (a) the arraying means and (b) the input/output channel array.

2. The multiplexer/demultiplexer of claim 1, further comprising an array of converging elements located between the input/output channel array and the converging element, each of the converging elements in the array corresponding to one of the input/output channels of the input/output channel array.

3. The multiplexer/demultiplexer of claim 1, additionally comprising a spatial filter located between the converging element and the arraying means.

4. The multiplexer/demultiplexer of claim 1, in which the arraying means includes a roof prism array comprising roof prisms equal in number to the input/output channels of the input/output channel array, less one.

5. The multiplexer/demultiplexer of claim 4, in which the roof prism array has a pitch equal to the predetermined pitch.

6. The multiplexer/demultiplexer of claim 1, in which the arraying means includes a roof prism array.

7. The multiplexer/demultiplexer of claim 6, in which the roof prism array comprises roof prisms arrayed in the second direction, the roof prisms differing in hypotenuse length.

8. The multiplexer/demultiplexer of claim 7, in which the roof prisms are offset from one another in a third direction orthogonal to the first direction and to the second direction.

9. The multiplexer/demultiplexer of claim 8, in which the roof prism array comprises roof prisms of substantially equal hypotenuse length arrayed in the second direction and offset from one another in the first direction.

10. The multiplexer/demultiplexer of claim 6, additionally comprising a spatial filter supported by the roof prism array.

11. The multiplexer/demultiplexer of claim 1, in which the arraying means includes an array of pair of reflective surfaces angled relative to one another, each pair defining an optical path length of a different path length in the first direction.

12. The multiplexer/demultiplexer of claim 1, in which the arraying means includes:
a prism array comprising prisms arrayed in the second direction, the prisms differing from one another in prism angle; and
a mirror located to receive light diffracted by the prism array and to return the light to the prism array.

13. The multiplexer/demultiplexer of claim 1, in which the arraying means includes:
a cylindrical converging element having an axis disposed in the second direction; and
a mirror array located to receive light converged by the converging element and comprising differently-angled reflective surfaces.

14. The multiplexer/demultiplexer of claim 1, in which:
the converging element focuses the light to a spot at the arraying means, the spot having a spot waist size; and
the spot waist size is less than one-eighth of the pitch at which the arraying means arrays the light.

15. The multiplexer/demultiplexer of claim 14, in which:
the multiplexer/demultiplexer additionally comprises a spatial filter located between the converging element and the arraying means, the spatial filter having a slit width; and
the slit width is approximately five times the spot waist size.

16. A method for demultiplexing a multi-wavelength optical signal, the method comprising:
receiving the multi-wavelength optical signal;
wavelength-dependently separating the multi-wavelength optical signal into single optical signals arrayed in a first direction, the single optical signals having different wavelengths;
wavelength-independently arraying the single optical signals in a second direction, different from the first direction;
wavelength-dependently reversing the arraying in the first direction; and individually outputting the single optical signals arrayed in the second direction.

17. The method of claim 16, additionally comprising:
collimating the multi-wavelength optical signal prior to the separating; and
focusing the single optical signals prior to the arraying.

18. The method of claim 17, in which:
each of the single optical signals has a spot size; and
the focusing includes changing the spot size of the single optical signals to a spot waist size at which each of the single optical signals is individually wavelength-independently arrayed.

19. The method of claim 16, additionally comprising:
focusing the single optical signals after the wavelength-dependent reversing; and
re-imaging the focused single optical signals prior to the receiving.

20. The method of claim 16, additionally comprising collimating the single optical signals prior to the wavelength-dependent reversing.

21. The method of claim 16, additionally comprising spatially filtering the single optical signals prior to the wavelength-independent arraying.

22. A method for multiplexing single optical signals to form a multi-wavelength optical signal, the method comprising:
receiving the single optical signals arrayed in a first direction, the single optical signals having different wavelengths;
wavelength-dependently arraying the single optical signals in a second direction, different from the first direction;
wavelength-independently reversing the arraying in the first direction;
wavelength-dependently reversing the arraying in the second direction to spatially overlap the single optical signals to form the single multi-wavelength optical signal; and
outputting the multi-wavelength optical signal.

23. The method of claim 22, additionally comprising:
collimating the single optical signals before the wavelength-dependent arraying; and
focusing the single optical signals before the wavelength-independent reversing of the arraying.

24. The method of claim 23, in which:
the single optical signals each have spot size; and
the focusing includes changing the spot size of the single optical signals to a spot waist size at which the arraying of each of the single optical signals is individually wavelength-independently reversed.

25. The method of claim 22, additionally comprising:
focusing the multi-wavelength optical signal after the wavelength-dependent reversing; and
re-imaging the multi-wavelength optical signal prior to the outputting.

26. The method of claim 22, additionally comprising spatially filtering the single optical signals one of (a) prior to and (b) after the wavelength-independent reversing of the arraying.
